(19) United States
(12) Patent Application Publication
(10) Pub. No.: US 2012/0174702 A1
(43) Pub. Date: Jul. 12, 2012

(54) BICYCLE PEDAL WITH ADJUSTER

(75) Inventor: Chung-I Chen, Taichung City (TW)

(73) Assignee: WELLGO PEDAL'S CORP., Taichung City (TW)

(21) Appl. No.: 13/004,888

(22) Filed: Jan. 12, 2011

(51) Int. Cl. B62M 3/08

(52) U.S. Cl. 74/594.6

(57) ABSTRACT

A bicycle pedal with adjuster includes a pedal and at least one adjuster mounted in the pedal. The pedal has at least one buckling frame pivotally mounted thereon. Each buckling frame has a spindle passing through the pedal and the buckling frame. The at least one buckling frame has at least one elastomer mounted therein. Each adjuster has a head formed on one end thereof and a first threaded portion formed on the other end thereof. Each adjuster has a second threaded portion formed between the first threaded portion and the head. A threaded direction of the first threaded portion is opposite to that of the second threaded portion. A block portion is screwed on the second threaded portion and a position member is screwed on the first threaded portion.

### BACKGROUND OF THE INVENTION

1. Field of the Invention

The present invention relates to a bicycle pedal, and more particularly to a bicycle pedal with adjuster.

2. Description of Related Art

A conventional clipless pedal structure for fixing fingers includes a pedal having an inserting portion and an elastic position device respectively disposed two sides thereof. The elastic position device is pivotally mounted on the conventional pedal and is composed of a lock sheet and an elastomer. The elastic position device is provided for fixing a cleat of a cycling shoe such that a rider is able to stably tread on the pedal for racing. The cleat of the cycling shoe assembled on/detached from the pedal is depended on a specific angle. In order to detaching the cleat from the conventional pedal, an adjusting device for adjusting a tension of the elastomer is necessary. A conventional adjusting device is a screw provided for compressing/releasing the elastomer such that a tension of the elastomer is adjusted. However, the screw for adjusting the elastomer is tiny such that the screw is easily lost during maintenance or operation. The screw is also easily loose and is disappeared when riding.

The present invention has arisen to mitigate and/or obviate the disadvantages of the conventional bicycle pedal.

### SUMMARY OF THE INVENTION

The main objective of the present invention is to provide an improved bicycle pedal, and more particular to a bicycle pedal with adjuster.

To achieve the objective, the bicycle pedal with adjuster in accordance with the present invention includes a pedal and at least one adjuster mounted in the pedal. The pedal has at least one buckling frame pivotally mounted thereon. Each buckling frame has a spindle passing through the pedal and the buckling frame for pivotally connecting the buckling frame with the pedal. The at least one buckling frame has at least one elastomer mounted therein for providing an elastic restitution force between the pedal and the buckling frame. Each adjuster has a head formed on one end thereof and a first threaded portion formed on the other end thereof. Each adjuster has a second threaded portion formed between the first threaded portion and the head. A threaded direction of the first threaded portion is opposite to that of the second threaded portion. A block portion is screwed on the second threaded portion and a position member is screwed on the first threaded portion such that the at least one adjuster is able to adjust the elastic restitution force between the pedal and the at least one buckling frame. The first threaded portion of each adjuster has a diameter being grater than that of the second threaded portion.

In the first and second embodiment of the present invention, the pedal is a clipless pedal and the elastomer is a spring. The spring is sleeved on the spindle. The spring has one end abutting against the pedal and the other end abutting against the block portion. The adjuster passes through the buckling frame. The head of the adjuster abuts against the buckling frame such that the buckling frame abuts against the spring and is elastically pivotable relative to the pedal for adapting to clip a cleat of a rider's cycling shoe. When the adjuster is rotated, the block portion is longitudinally moved relative to the head for adjusting the elastic restitution force of the spring. The position member is provided for preventing the block portion detaching from the adjuster.

In the third embodiment of the present invention, the pedal is a cushioning pedal and the elastomer is an elastic tube. The adjuster passes through the buckling frame and screws on the pedal. The head abuts against the buckling frame. The block portion has a threaded hole defined in the pedal for engaging with the second threaded portion. The elastic tube is sleeved on the adjuster. The elastic tube has one end abutting against the buckling frame and the other end abutting against the pedal. When the adjuster is rotated, the head is relatively moved relative to the blocking portion to compress/release the elastic tube for adjusting the elastic restitution force. The position member is provided for preventing the adjuster detaching from the pedal. The threaded hole has a stepped structure for correspondingly receiving the position member.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adjuster in accordance with the present invention;

FIG. 2 is an assembled perspective view of a bicycle pedal with adjuster in accordance with the present invention;

FIG. 3 is a top plan view of the bicycle pedal with adjuster in accordance with the present invention;

FIGS. 4-5 are side cross-sectional operational views of the bicycle pedal with adjuster in accordance with the present invention taken along line A-A in FIG. 3;

FIG. 6 is a top plan view of a second embodiment of the bicycle pedal with adjuster in accordance with the present invention;

FIG. 7 is a side cross-sectional operational view of the second embodiment of the bicycle pedal with adjuster in accordance with the present invention taken along line B-B in FIG. 6;

FIG. 8 is an exploded perspective view of a third embodiment of the bicycle pedal with adjuster in accordance with the present invention;

FIG. 9 is an assembled perspective view of the third embodiment of the bicycle pedal with adjuster in accordance with the present invention; and

FIG. 10 is a side cross-sectional operational view of the third embodiment of the bicycle pedal with adjuster in accordance with the present invention.

### DETAILED DESCRIPTION OF THE INVENTION

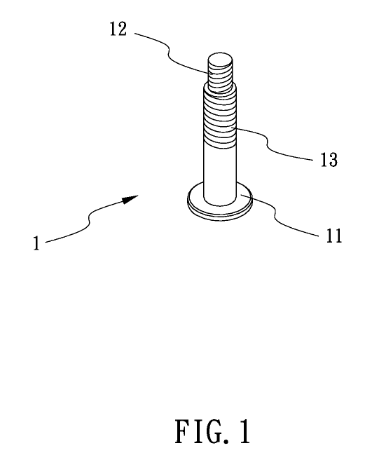

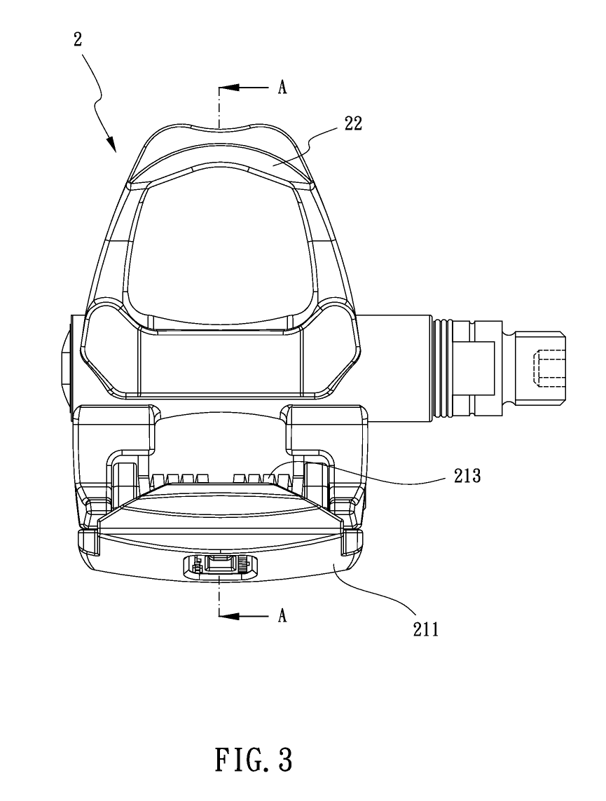

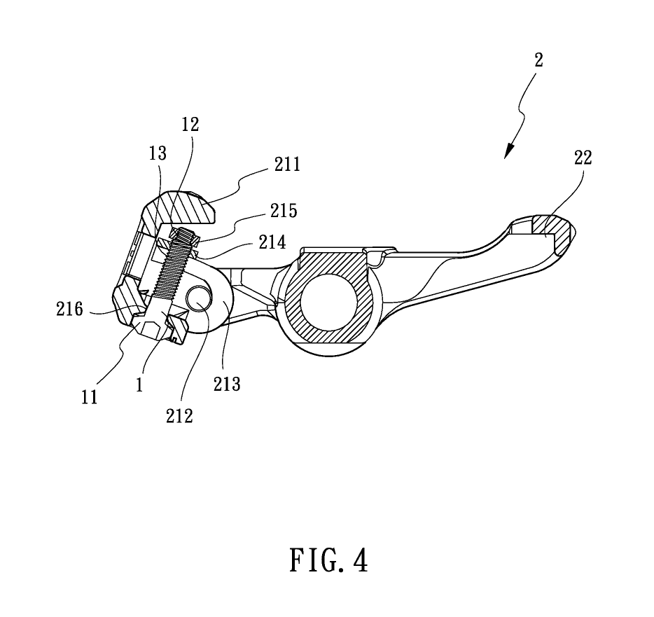

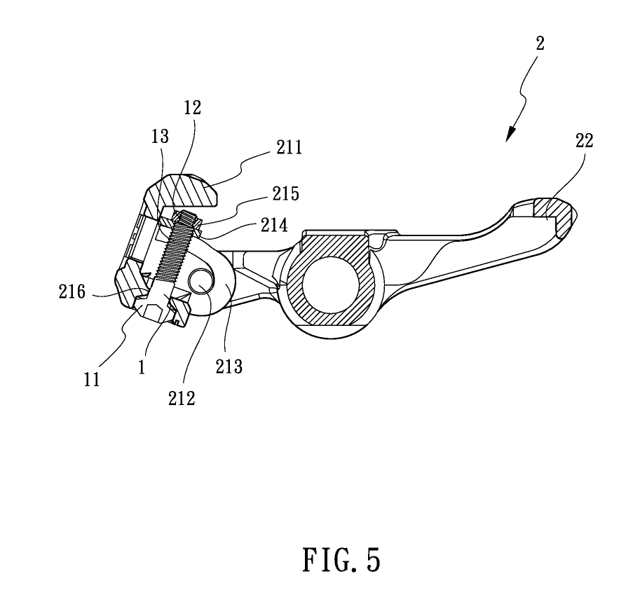

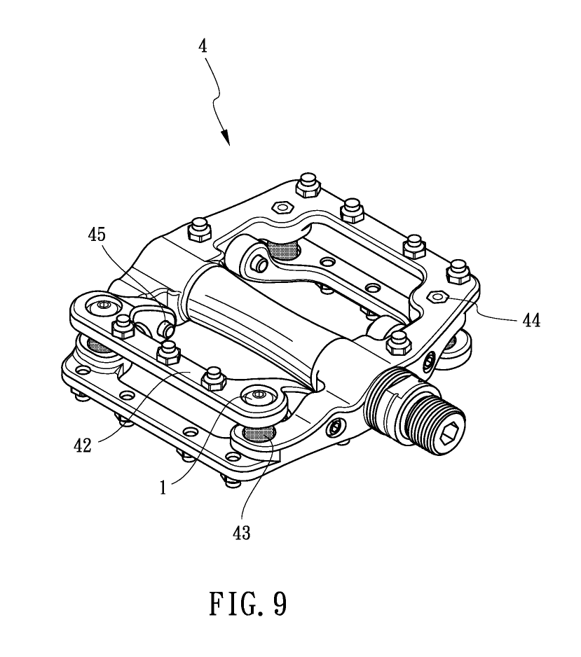

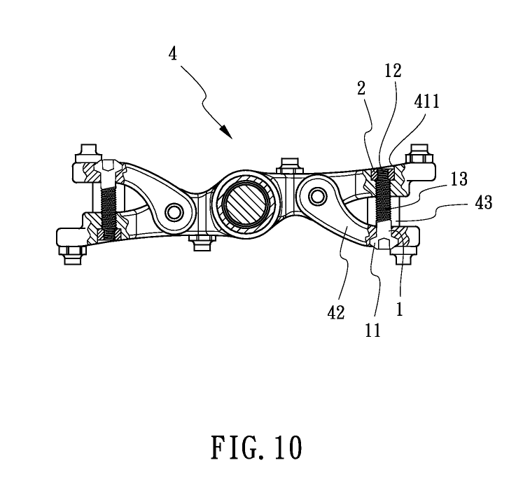

Referring to the drawings and initially to FIGS. 1-10, a bicycle pedal with adjuster in accordance with the present invention comprises a pedal 2 and at least one adjuster 1 mounted in the pedal 2.

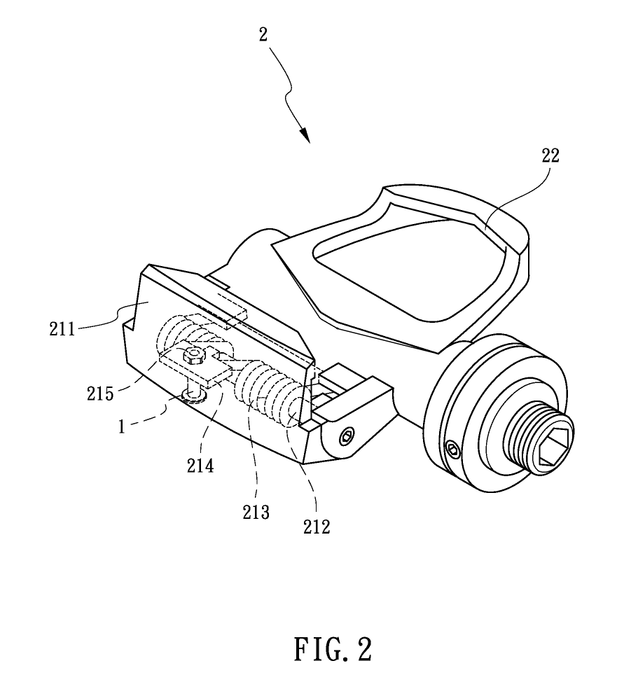

As shown in FIGS. 2-5, the pedal 2 is a clipless pedal for a racing bike. The pedal 2 has at least one buckling frame 211 pivotally mounted thereon. In the first embodiment of the present invention, the pedal 2 has a buckling frame 211 pivotally mounted in a lateral end thereof and an inserting portion 22 formed on the other lateral end thereof which is opposite to the buckling frame 211. The buckling frame 211 is provided for adapting to clip a cleat (not shown) of a rider's cycling shoe and the inserting portion 22 is provided for adapting to fix the cleat. The buckling frame 211 has a spindle 212 passing through the pedal 2 and the buckling frame 211 for pivotally connecting the buckling frame 211 with the pedal 2. The buckling frame 211 has an elastomer mounted therein for providing an elastic restitution force between the pedal 2 and the buckling frame 211. In the first embodiment of the present invention, the elastomer is a spring 213. The spring 213 is sleeved on the spindle 212. The buckling frame 211 has a through hole 216 defined therein and passing therethrough.

The at least one adjuster 1 is provided for adjusting the elastic restitution force of the elastomer. In the first embodiment of the present invention, the pedal 2 has an adjuster 1 passing through the through hole 216 in the buckling frame 211. The adjuster 1 has a head 11 formed on one end thereof and a first threaded portion 12 formed on the other end thereof. The adjuster 1 has a second threaded portion 13 formed between the first threaded portion 12 and the head 11. A threaded direction of the first threaded portion 12 is opposite to that of the second threaded portion 13. The head 11 has a diameter being greater than an inner diameter of the through hole 216. The first threaded portion 12 has a diameter being relatively smaller than that of the second threaded portion 13. The head 11 of the adjuster 1 abuts against an edge of the through hole 216 in the buckling frame 211. A block portion 214 is screwed on the second threaded portion 13 of the adjuster 1. The block portion 214 has a sheet structure and is located in the buckling frame 211. The spring 213 has one end abutting against the block portion 214 and the other end abutting against the pedal 2 for providing the elastic restitution force to the buckling frame 211 relative to the pedal 2. A position member 215 is screwed on the first threaded portion 12 to prevent the block portion 214 detaching from the adjuster 1. In the first embodiment, the position member 215 is a nut.

When the adjuster 1 is rotated, the block portion 214 is longitudinally moved relative to the head 11 and a tension of the spring 213 is adjusted for adjusting the elastic restitution force between the buckling frame 211 and the pedal 2. The buckling frame 211 is elastically pivotable relative to the pedal 2 for clipping the cleat of the cycling shoe.

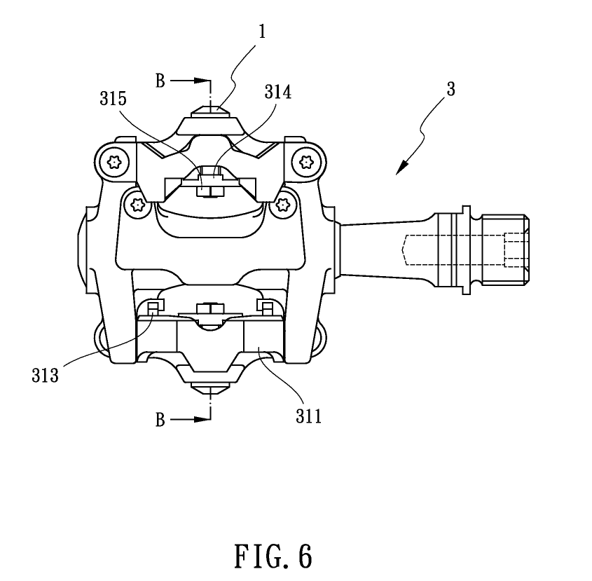

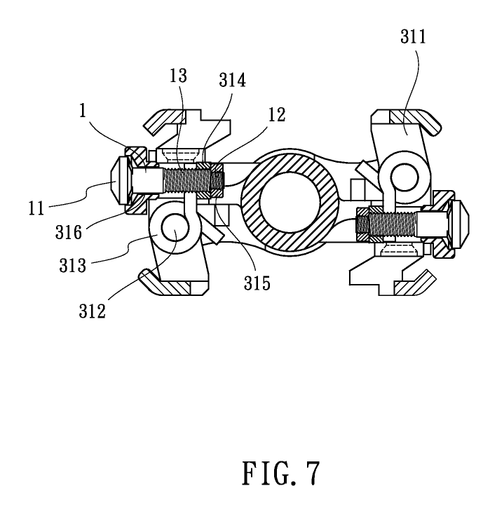

With reference to FIGS. 6-7, that shows a second embodiment of the bicycle pedal with adjuster in accordance with the present invention. The elements and effects of the second embodiment which are the same with the first embodiment are not described, only the differences are described. The pedal 3 is a clipless pedal for mountain bike. The pedal 3 has two buckling frames 311 respectively pivotally mounted in two lateral ends thereof. The two buckling frames 311 are respectively positioned on a top and a bottom of the pedal 3 to provide two sides for selectively clipping the cleat of the cycling shoe. Each buckling frame 311 has a spindle 312 passing through the pedal 3 and the buckling frame 311 for pivotally connecting the buckling frame 311 with the pedal 3. Each buckling frame 311 has an elastomer mounted therein for providing elastic restitution force between the pedal 3 and the buckling frame 311. In the second embodiment of the present invention, the elastomer is a spring 313. The spring 313 is sleeved on the spindle 312. Each buckling frame 311 has a through hole 316 defined in a lateral thereof and passing therethrough. Two adjusters 1 are respectively mounted in two buckling frames 311. Each adjuster 1 of the second embodiment is the same with that of first embodiment. Each adjuster 1 passes through the through hole 316 in the corresponding buckling frame 311. The head 11 of each adjuster 1 abuts against an edge of the through hole 316. The sheet-liked block portion 314 is screwed on the second threaded portion 13 of the adjuster 1. The block portion 314 is located in the buckling frame 311. The spring 313 has one end abutting against the block portion 314 and the other end abutting against the pedal 3 for providing the elastic restitution force to the buckling frame 311 relative to the pedal 3. The position member 315 is screwed on the first threaded portion 12 of the adjuster 1 to prevent the block portion 314 detaching from the adjuster 1. In the second embodiment, the position member 315 is also a nut.

When the adjuster 1 of the second embodiment is rotated, the block portion 314 is longitudinally moved relative to the head 11 and a tension of the spring 313 is adjusted for adjusting the elastic restitution force between the buckling frame 311 and the pedal 3. The buckling frame 311 is elastically pivotable relative to the pedal 3 for clipping the cleat of the cycling shoe.

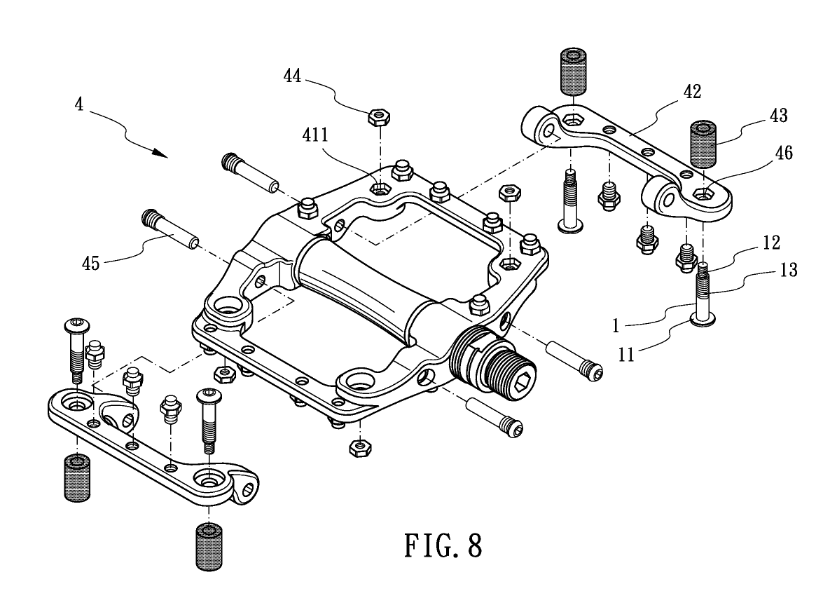

With reference to FIGS. 8-10, that shows a third embodiment of the bicycle pedal with adjuster in accordance with the present invention. The elements and effects of the third embodiment which are the same with the first embodiment are not described, only the differences are described. The pedal 4 is a cushioning pedal. The pedal 4 has two buckling frames 42 respectively pivotally mounted in two lateral ends thereof. The two buckling frames 42 are respectively positioned on a top and a bottom of the pedal 4 to provide a cushion effect. Each buckling frame 42 has a spindle 45 passing through the pedal 4 and the buckling frame 42 for pivotally connecting the buckling frame 42 with the pedal 4. Each buckling frame 42 has two elastomers mounted therein and positioned between the buckling frame 42 and the pedal 4 for providing the elastic restitution force between the pedal 4 and the buckling frame 42. In the third embodiment of the present invention, each elastomer is an elastic tube 43. Each buckling frame 42 has two through holes 46 defined therein and passing therethrough. Each buckling frame 42 has two adjusters 1 respectively passing through the two through holes 46 and respectively passing through the two elastic tubes 43 to connect with the pedal 4. Each adjuster 1 of the third embodiment is the same with that of first embodiment. The head 11 of each adjuster 1 abuts against an edge of the through hole 46. Each elastic tube 43 is sleeved on a corresponding adjuster 1. Four block portions are respectively engaged with the second threaded portions 13 of the four adjusters 1. In the third embodiment of the present invention, the four block portions are four threaded holes 411 defined in the pedal 4 and respectively corresponding to the through holes 46 in the two buckling frames 42, such that each adjuster 1 is able to pass through the corresponding through hole 46 and the corresponding elastic tube 43, then screws into the corresponding threaded hole 46. Four position members 44 are respectively screwed on the first threaded portions 12 of the four adjusters 1 to prevent the adjusters 1 detaching from the pedal 4. In the third embodiment, the position member 44 is also a nut. Each threaded hole 411 has a stepped structure for correspondingly receiving the position member 44, such that each position member 44 is able to fully be embedded into the corresponding threaded hole 411 for unobstructing the operation of the pedal 4.

When each adjuster 1 of the third embodiment is rotated, the head 11 of the adjuster 1 is moved relative to the pedal 4 for compressing/releasing the corresponding elastic tube 43 to adjust the elastic restitution force.

Based on the threaded direction of the first threaded portion 12 being opposite to that of the second threaded portion 13, a pressure for detaching the clipless pedal 2, 3 is adjustable and the cushioning effect of the cushioning pedal 4 is adjustable. The adjuster 1 of the present invention is stably tightened on the buckling frame for preventing from loosening, detaching or missing.

Although the invention has been explained in relation to its preferred embodiment, it is to be understood that many other possible modifications and variations can be made without departing from the spirit and scope of the invention as hereinafter claimed.

What is claimed is:

1. A bicycle pedal with adjuster, comprising:
a pedal, the pedal having at least one buckling frame pivotally mounted thereon, each buckling frame having a spindle passing through the pedal and the buckling frame for pivotally connecting the buckling frame with the pedal, the at least one buckling frame having at least one elastomer mounted therein for providing an elastic restitution force between the pedal and the buckling frame;
at least one adjuster mounted in the pedal for adjusting the elastic restitution force of the elastomer, each adjuster having a head formed on one end thereof and a first threaded portion formed on the other end thereof, each adjuster having a second threaded portion formed between the first threaded portion and the head, a threaded direction of the first threaded portion being opposite to that of the second threaded portion, a block portion screwed on the second threaded portion and a position member screwed on the first threaded portion such that the at least one adjuster is able to adjust the elastic restitution force between the pedal and the at least one buckling frame.

2. The bicycle pedal with adjuster as claimed in claim 1, wherein the first threaded portion of each adjuster has a diameter being relatively smaller than that of the second threaded portion.

3. The bicycle pedal with adjuster as claimed in claim 1, wherein the pedal is a clipless pedal and the elastomer is a spring, the spring sleeved on the spindle, the spring having one end abutting against the pedal and the other end abutting against the block portion, the at least one adjuster passing through the buckling frame, the head of the at least one adjuster abutting against the buckling frame such that the buckling frame abuts against the spring and is elastically pivotable relative to the pedal for adapting to clip a cleat of a rider's cycling shoe;
wherein when the adjuster is rotated, the block portion is longitudinally moved relative to the head for adjusting the elastic restitution force of the spring, the position member is provided for preventing the block portion detaching from the adjuster.

4. The bicycle pedal with adjuster as claimed in claim 1, wherein the pedal is a cushioning pedal and the at least one elastomer is an elastic tube, the at least one adjuster passing through the buckling frame and screwed on the pedal, the head abutting against the buckling frame, the block portion being a threaded hole defined in the pedal for engaging with the second threaded portion, the elastic tube sleeved on the at least one adjuster, the elastic tube having one end abutting against the buckling frame and the other end abutting against the pedal;
wherein when the adjuster is rotated, the head is relatively moved relative to the blocking portion to compress/release the elastic tube for adjusting the elastic restitution force, the position member is provided for preventing the adjuster detaching from the pedal.

5. The bicycle pedal with adjuster as claimed in claim 4, wherein the threaded hole has a stepped structure for correspondingly receiving the position member.
